(19) United States
(12) Patent Application Publication
(10) Pub. No.: US 2008/0179175 A1
(43) Pub. Date: Jul. 31, 2008

(54) Desalination process

(76) Inventor: Kurt Lehovec, Los Angeles, CA (US)

Correspondence Address: Dr. Kurt Lehovec, 200 S. Westmoreland Ave., Los Angeles, CA, 90004, US

(21) Appl. No.: 11/657,744

(22) Filed: Jan. 25, 2007

(51) Int. Cl. B01D 3/10

(52) U.S. Cl. 203/11; 203/91

(57) ABSTRACT

Saltwater is boiled in a vacuum generated by a pump and its water vapor exhaust is condensed into purified water.

### BACKGROUND OF THE INVENTION

There are three existing processes for water purification: Filtering by osmosis, freezing and distillation. The conventional distilling process is a batch process, requiring an energy input for boiling the liquid. This is unsuitable for a continuous inexpensive large scale pure water production from saltwater. The aim of my invention is an energy efficient continuous distillation from an unlimited contaminated water supply, such as the desalination of sea water.

### SUMMARY OF THE INVENTION

Water vapor is transferred from a first container of the contaminated water to a second container for the purified water through a duct containing a mechanical vacuum pump. The pressures generated by the pump are sufficiently low in the first container to cause the water to boil, and high in the second container to cause the water vapor to condense.

### BRIEF DESCRIPTION OF THE DRAWINGS

FIG. 1 shows a first container with a contaminated liquid and a duct for vapor from that liquid leading to a second container for condensation of said vapor into the purified liquid. A vacuum pump inserted in the duct extracts vapor from the first container and exhaust it into the second container. The containers are in thermal contact to counteract the cooling of the contaminated liquid due to evaporation by the heating of the purified liquid due to condensation.

FIG. 2 is an adaptation of the still of FIG. 1 to the desalination of sea water. A vacuum pump sucks sea water into a pipe whose upper end is sufficiently elevated to leave an air space into which the sea water evaporates. A parabolic mirror provides preheating of the sea water in the pipe to enhance its evaporation. The sea water is circulated through the pipe by an elaborate siphoning system.

### PREFERRED EMBODIMENTS

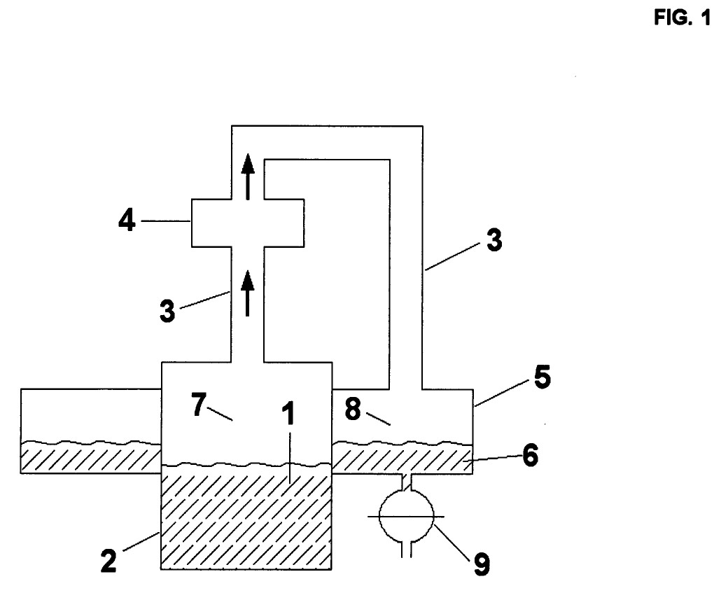

The distillation process shown in FIG. 1 evaporates contaminated water 1 in a container 2 through a duct 3 by a vacuum pump 4 and condenses the water vapor exhaust from the pump in a container 5 as purified water 6.

Rapid evaporation is assured by the pressure in the air space 7 above the contaminated water 1 being less than its saturation vapor pressure, causing the water 1 to boil.

Condensation of the water 6 in 5 occurs when the water vapor pressure in the air space 8 reaches the saturation water vapor pressure.

The drainage valve 9 of the container 5 is open during the initial evacuation of 7 and is closed, when the water 1 starts to boil. An auxiliary small vacuum pump, not shown in the FIG. 1, may be used to evacuate the air in the container 6 through the valve 9 before it is closed.

Evaporation of water requires the energy 10.27 Kcal per Mol of water. One Mol of water is 18 grams. This energy is released by condensation. Thus the contaminated water 1 is cooled by evaporation and the purified water 6 is heated by condensation. This is undesirable because the vapor pressure decreases with temperature and thus reduces the water transport rate through the pump and accordingly the rate of generating purified water. The cooling effect is ameliorated by intimate thermal contact of the containers 2 and 5. For a quantitative analysis I use the mechanical vacuum pump model 175A sold by the Associated Vacuum Technology, Inc. The pump evacuates to 0.4″Hg=10 Torr at a pumping speed of 1060 cubic feet per minute, which amounts to 0.5 m³/sec.

The density of water vapor of 1 atm=760 Torr is 0.768 mg/cm³ and the density at 10 Torr is thus about 0.01 mg/cm³=10 g/m³. Thus the pump removes 5 grams of water per second from the contaminated water 1 at a vapor pressure of 10 Torr.

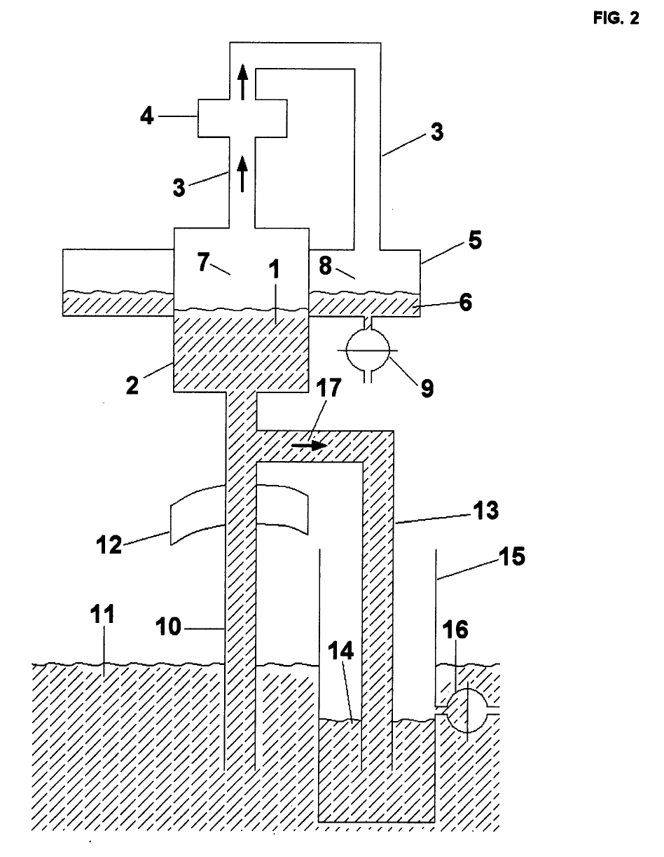

The pumping speed is almost independent of the pressure, so that pumping at a higher water vapor pressure would provide a correspondingly larger generation rate of purified water. The saturated water vapor pressure of 10 Torr corresponds to a water temperature of 10° C. Preheating of the contaminated water 1 to 52° C. and pumping at the corresponding saturated water vapor pressure of 100 Torr increase the generation rate of purified water to 50 grams per second. Referring now to FIG. 2, there is shown an adaptation of my invention for the generation of desalinated water from sea water. The lower end of the pipe 10 is dipped into the sea 11 and the upper elevated end is connected to the container 2. Evacuation by the pump 4 causes sea water 11 to rise into the pipe 10 and the container 2 to an elevation of about 10 meters by the atmospheric pressure at sea level. This leaves an empty air space 7, into which sea water evaporates. The elevation of the pump 4 above the container 2 must be sufficiently large to prevent flooding of the pump with sea water by the tides. The container 5 for the purified sea water 6 is wrapped around the container 2 to provide the a-fore-mentioned intimate thermal contact. The sea water column in the pipe 10 is heated by focusing sun light on the pipe 10 by the parabolic mirror 12 to increases the saturation vapor pressure and thus the efficiency of the desalination process.

The cooling of the sea water by evaporation is reduced by circulation of the sea water through the pipe 10 by a siphoning system for sea water through the return pipe 13. This circulation has the additional advantage of preventing excessive salt build-up arising from the evaporation of water in the container 2.

Sea water circulates through the pipes 10 and 13 by siphoning between the open sea 11 and sea water 14 in the container 15, which is pre-filled with sea water through the valve 16 before the start of the evacuation during which the valve 16 is closed.

Both pipes always dip into the respective sea waters even at low tide. In the high state of tide depicted in FIG. 2 sea water siphons into the container 15, as suggested by the arrow 17, until the sea water levels of 11 and 14 are equal. With diminishing tide the ocean water level sinks below that in the tank 15 and water then siphons from it back into the ocean. The elevation of the pump 4 above the tank 2 must exceed the difference between low and high tides to prevent flooding of the pump 4 with sea water at high tide.

The system illustrated in FIG. 2 is design for continuous operator-free operation.

As there are many other embodiments of my invention, it should not be limited to the embodiments disclosed, but should include all purification processes of a contaminated liquid subject to the following claims.

What is claimed is:

1. A distilling process for extracting purified liquid from a contaminated liquid, said process comprising a vacuum pump to evacuate a confined space above said contaminated liquid to cause it to boil, and subsequent condensation of the vapor exhaust from said pump as said purified liquid.

2. The process of claim 1 with said contaminated liquid being salt water of the ocean, the lower end of a pipe inserted in said ocean, said vacuum pump connected to the upper end of said pipe so that atmospheric pressure forces ocean water into said evacuated pipe, said upper end sufficiently elevated to leave said confined space between said ocean water in said pipe and said pump.

3. The process of claim 2 with said water vapor exhaust from said pump condensed in a confined space in thermal contact with to said boiling contaminated water in said pipe, so that the heat generated by said condensation counteracts the cooling by said boiling.

4. The process of claim 2 with focusing means of sun radiation on said pipe to heat said ocean water in said pipe.

5. The process of claim 2 with a return branch from said pipe providing circulation of said ocean water sucked into said pipe through said return branch into a tank containing ocean water, said circulation by siphoning activated by the ocean tides.
